(19) United States
(12) Patent Application Publication
(10) Pub. No.: US 2005/0210090 A1
(43) Pub. Date: Sep. 22, 2005

(54) Logarithm determining method and apparatus for the same

(75) Inventor: Chin-Shu Yao, Shengang Township (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/082,045

(22) Filed: Mar. 16, 2005

(30) Foreign Application Priority Data
Mar. 16, 2004 (TW) 93106945

(51) Int. Cl. G06F 1/02

(52) U.S. Cl. 708/277

(57) ABSTRACT

A logarithm determining method for use in a digital processor is provided. The method is for converting an input number x into a logarithm L by a base b. The logarithm L includes an integer part In and a mantissa part Ma. The method represents numbers in a fixed-point format. The method comprises the steps of: designating a number of digits of precision k for said mantissa part Ma; creating a plurality of reference tables based on said base b, wherein a number of said plurality of reference tables is equal to said number of digits of precision k and an m-th reference table is for evaluating an m-th digit to the right of the decimal point of said mantissa part Ma; calculating said integer part In; and searching in said plurality of reference tables sequentially to obtain a values from a first to a k-th digit to the right of the decimal point of said mantissa part Ma.

### CROSS-REFERENCE TO RELATED APPLICATIONS

This Application claims the right of priority based on Taiwan Patent Application No. 093106945 filed on Mar. 16, 2004.

### FIELD OF INVENTION

The present invention relates to a logarithm determining method and the apparatus for the same.

### BACKGROUND OF THE INVENTION

When processing digital signals, sometimes, a number needs to be converted into a logarithm form first. There are several ways to convert a logarithm. For example, a floating-point format can be used to represent numbers, and a power series or Newton-Raphson method is used to round off the numbers; alternatively, a reference table can be used, or one can only calculate the integer part of the number and ignore the mantissa part.

However, the method using the floating-point format to represent numbers and then using the power series or Newton-Raphson method to round off the numbers is very complex, wasting both time and hardware resources. Additionally, it is very difficult and expensive for a hardware utilizing a fixed-point format to simulate a floating format by software. As for the reference tables, a logarithm table needs to be established first. It is needed to pre-save a great number of digits of precision, when an exact mantissa part is requested, and thus occupying a lot of memory space. Nevertheless, calculation to the integer part is not precise enough. Therefore, a simple logarithm determining method and the apparatus for the same, having enough precision, is needed.

### SUMMARY OF THE INVENTION

An object of the present invention is to provide a simple logarithm determining method and an apparatus for the same with a desired precision. Depending on the number of digits of precision required on the mantissa part, the present invention creates a reference table having the same number of digits of precision as required. The m-th reference table can be used for calculating to the m-th decimal place of the mantissa part. Because the present invention utilizes the reference table, it is easier than representing the numbers in the floating format and then rounding off the numbers. The number of reference tables is dependent on the number of digits of precision required, and thus memory space is smaller than in the case of the conventional method using the reference tables. In addition, designating a number of digits of precision as desired is also more precise than calculating only to the integer part.

The present invention provides a logarithm determining method in a digital processor. The logarithm determining method converts an input number x into a logarithm L by a base b. The logarithm L includes an integer part In and a mantissa part Ma. The method represents numbers in a fixed-point format. The method comprises the following steps. The number of digits of precision for the mantissa part Ma, k, is designated. A plurality of reference tables is created based on the base b. The number of the plurality of reference tables is equal to k, the number of digits of precision for the mantissa part Ma. The m-th reference table is for evaluating the m-th digit to the right of the decimal point of the mantissa part Ma. The integer part In is calculated. The plurality of reference tables is searched sequentially to evaluate the 1st to the k-th digit to the right of the decimal point of the mantissa part Ma.

The above-mentioned calculating step can include the following steps: searching for a number y such that the base b to the y-th power is not greater than the input number x, and the base b to the (y+1)-th power is greater than the input number x; and outputting the number y as the integer number In.

Each reference table mentioned above can have 10 entries. The above-mentioned creating step can include the following steps: determining a coefficient SCₘ for the m-th of the plurality of reference tables; and rooting 10^{m} the base b to the n-th power, and then multiplying it by the coefficient SCₘ to be the n-th entry of the m-th of the plurality of the reference tables, where n=0, . . . ,9; and the coefficient SCₘ is for extending intervals among the ten entries. The coefficient SCₘ is a power series of 2.

The above-mentioned searching step includes the following steps: setting m=1; if m=1, obtaining a temporary value Temp, by eliminating the integer part In in the input number x, and then multiplied by the coefficient SCₘ; or else, obtaining the temporary value Temp, by eliminating the portion from the first to the (m−1)-th digits to the right of the decimal points of the integer part In and of the mantissa part Ma in the input number, and then multiplied by the coefficient SCₘ; searching for the n-th entry Tabₘ[n] of the m-th of the plurality of said reference tables such that Tabₘ[n] is not greater than the temporary value Temp, and Tabₘ[n+1] is greater than said temporary value Temp; outputting n as the m-th digit to the right of the decimal points of the mantissa part Ma; adding m by 1; comparing m with the number of digits of precision k; and if m is not greater than the number of digits of precision k, repeat from calculating the temporary value Temp to comparing m and the number of digits of precision k.

The present invention also provides a logarithm determining apparatus for converting an input number x into a logarithm L by a base b. The logarithm L includes an integer part In and a mantissa part Ma. The apparatus can represent any numbers, using a fixed-point format. The apparatus includes a designating device, a creating device, a calculating device, and a searching device. The designating device is for designating k as a number of digits of precision for the mantissa part Ma. The creating device is for creating a plurality of reference tables based on the base b. The number of the plurality of reference tables equals the number of digits of precision k. An m-th reference table is for evaluating an m-th digit to the right of the decimal point of the mantissa part Ma. The calculating device is for calculating the integer part In. The searching device is for searching the plurality of reference tables sequentially to obtain a first to a k-th digit to the right of the decimal point of the mantissa part Ma.

The above-mentioned calculating device can include a first searching unit and a first output unit. The first searching unit is for searching for a number y such that the base b to the y-th power is not greater than the input number x, and the base b to the (y+1)-th power is greater than the input number x. The first output unit for outputting the number y as the integer number In.

Each of the above mentioned reference tables can have 10 entries. The above-mentioned creating device can include a determining unit and a first computing unit. The determining unit is for determining a coefficient SCₘ for the m-th of the plurality of reference tables. The first computing unit for rooting 10^{m} the base b to the n-th power, and then multiplied by the coefficient SCₘ to be the n-th entry of the m-th of the plurality of the reference tables, where n=0, . . . ,9, wherein the coefficient SCₘ is for extending intervals among the ten entries.

The above mentioned searching device can include a setting unit, a second computing unit, a second searching unit, a second output unit, an adding unit, a comparing unit, and a logic unit. The setting unit is for setting m=1. If m=1, the second computing unit is operable to obtain a temporary value Temp, by eliminating the integer part In in the input number x, and then multiplied by the coefficient SCₘ; or else, obtaining the temporary value Temp, by eliminating the portion from the first to the (m−1)-th digits to the right of the decimal points of the integer part In and of the mantissa part Ma in the input number, and then multiplied by the coefficient SCₘ. The second searching unit is for searching for the n-th entry Tabₘ[n] of the m-th of the plurality of the reference tables such that Tabₘ[n] is not greater than the temporary value Temp, and Tabₘ[n+1] is greater than the temporary value Temp. The second output unit is for outputting n as the m-th digit to the right of the decimal points of the mantissa part Ma. The adding unit is for adding m by 1. The comparing unit is for comparing m with the number of digits of precision k. If m is not greater than the number of digits of precision k, the logic unit is for asking the second computing unit, the second searching unit, the second output unit, the adding unit and the comparing unit to repeat the steps accordingly.

### BRIEF DESCRIPTION OF THE DRAWINGS

FIG. 1 is a data flow diagram of an embodiment of the logarithm determining method in accordance with the present invention;

FIG. 2 is a block diagram of an embodiment of the logarithm determining apparatus in accordance with the present invention; and

FIG. 3 is an embodiment of the reference table of the present invention.

### DETAILED DESCRIPTION

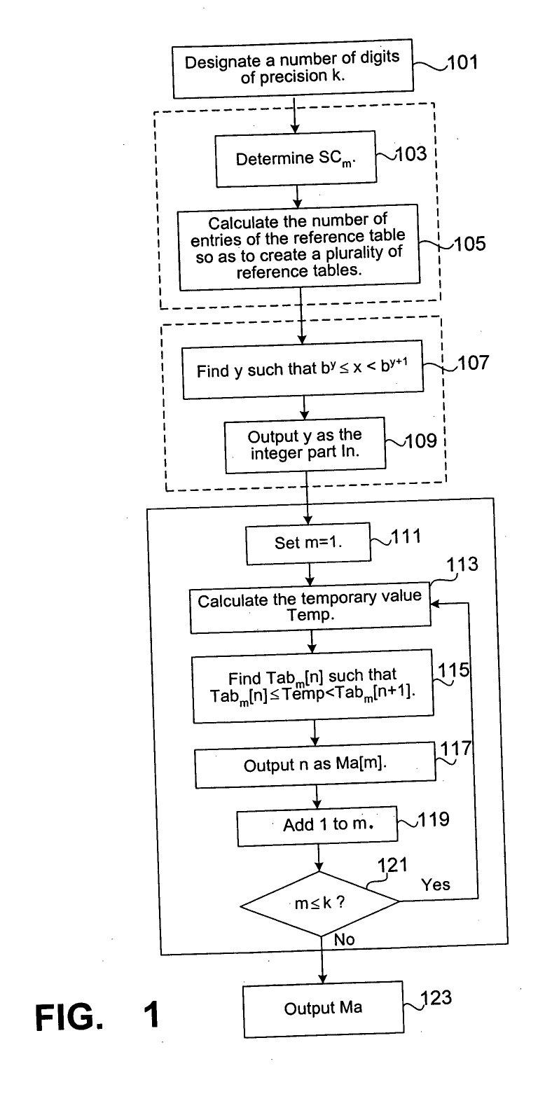

FIG. 1 is a data flow diagram of an embodiment of the logarithm determining method in accordance with the present invention. An embodiment of the logarithm determining method is used in a digital processor for converting an input number x into a logarithm L by a base b. The logarithm L includes an integer part In and a mantissa part Ma. The method represents numbers in the fixed-point format.

The method includes the following steps. In step 101, k is designated to the number of digits of precision for the mantissa part Ma. A plurality of reference tables is created based on the base b. The number of the plurality of reference tables is equal to k, the number of digits of precision for the mantissa part Ma. The m-th reference table is for evaluating the m-th digit to the right of the decimal point of the mantissa part Ma. Each reference table can have 10 entries. The above-mentioned creating step can include the following steps. In step 103, a coefficient SCₘ for the m-th of the plurality of reference tables is determined. The coefficient for each reference table may be different. The coefficient SCₘ is for extending the intervals among the 10 entries. If the interval is sufficient, SCₘ−1. The coefficient SCₘ is a power series of 2 so as to facilitate the computation in binary representation. Then, in step 105, the base b to the n-th power is rooted 10^{m}, and then multiplied by the coefficient SCₘ so as to be the n-th entry of the m-th of the plurality of the reference tables, where n=0, . . . ,9.

Furthermore, the integer part In is calculated. The calculating step can include the following. In step 107, a number y is searched for such that the base b to the y-th power is not greater than the input number x, and the base b to the (y+1)-th power is greater than the input number x. In step 109, the number y is output as the integer number In.

The plurality of reference tables is searched sequentially to evaluate the 1st to the k-th digit to the right of the decimal point of the mantissa part Ma. The searching step can include the following. In step 111, m=1 is set. In step 113, if m=1, a temporary value Temp is obtained by eliminating the integer part In in the input number x, and then multiplying it by the coefficient SCₘ; or else, the temporary value Temp is obtained by eliminating the portion from the first to the (m−1)-th digits to the right of the decimal points of the integer part In and of the mantissa part Ma in the input number, and then multiplying it by the coefficient SCₘ. In step 115, the n-th entry Tabₘ[n] of the m-th of said plurality of the reference tables is searched such that Tabₘ[n] is not greater than the temporary value Temp, and Tabₘ[n+1] is greater than the temporary value Temp. In step 117, n is output as the m-th digit to the right of the decimal points of the mantissa part Ma. In step 119, m is added by 1. In step 121, m is compared with the number of digits of precision k. If m is not greater than the number of digits of precision k, repeat from the step of calculating the temporary value Temp to the step of comparing m and the number of digits of precision k (steps 113-121). In step 123, if m is greater than k, then the number of digits to the right of the decimal point of the mantissa part Ma is output. There are many ways to implement the above mentioned searching Tabₘ[n] step, namely step 115; for example, size can be compared from the zeroith entry, or from the fourth or the fifth entry.

Although the creating step (steps 103-105) is prior to the calculating step (steps 107-109), the calculating step (step 107-109) can also be implemented prior to the creating step (steps 103-105). Alternatively, the 2 steps can be processed simultaneously.

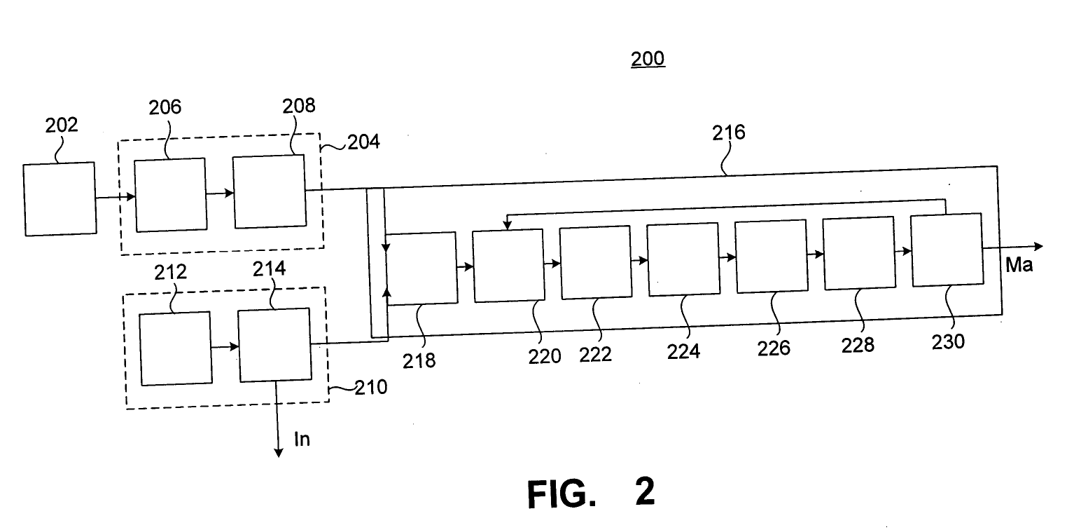

FIG. 2 is a block diagram of an embodiment of the logarithm determining apparatus 200 in accordance with the present invention. The logarithm determining apparatus 200 is for converting an input number x into a logarithm L by a base b. The logarithm L includes an integer part In and a mantissa part Ma. The logarithm determining apparatus 200 represents numbers in the fixed-point format. The embodiment 200 includes a designation device 202, a creating device 204, a calculating device 210, and a searching device 216.

The designating device 202 is for designating k as a number of digits of precision for the mantissa part Ma. The creating device 204 is for creating a plurality of reference tables based on the base b. The number of the plurality of reference tables equals the number of digits of precision k. An m-th reference table is for evaluating an m-th digit to the right of the decimal point of the mantissa part Ma. Each of the reference tables mentioned above can have 10 entries. The creating device 204 includes a determining unit 206 and a first computing unit 208. The determining unit 206 is for determining a coefficient SCₘ for the m-th of the plurality of reference tables. The coefficient for each reference table can be different. The coefficient SCₘ is for extending the intervals among the 10 entries. If the interval is sufficient, SCₘ can be equal to 1. The coefficient SCₘ can be a power series of 2 so as to facilitate the computation in a binary representation. The first computing unit 208 is for rooting 10^{m} the base b to the n-th power, and then multiplying it by the coefficient SCₘ to be the n-th entry of the m-th of the plurality of the reference tables, where n=0, . . . ,9.

The calculating device 210 is for calculating the integer part In. The calculating device 210 can include a searching unit 212 and a first output unit 214. The first searching unit 212 is for searching for a number y such that the base b to the y-th power is not greater than the input number x, and the base b to the (y+1)-th power is greater than the input number x. The first output unit 214 is for outputting the number y as the integer number In.

The searching device 216 is for searching in the plurality of reference tables sequentially to obtain a first to a k-th digit to the right of the decimal point of the mantissa part Ma. The searching device 216 can include a setting unit 218, a second computing unit 220, a second searching unit 222, a second output unit 224, an adding unit 226, a comparing unit 228, and a logic unit 230. The setting unit 218 is for setting m=1. If m=1, the second computing unit 220 is operable to obtain a temporary value Temp by eliminating the integer part In in the input number x, and then multiplying it by the coefficient SCₘ; or else, obtaining the temporary value Temp, by eliminating the portion from the first to the (m−1)-th digits to the right of the decimal points of the integer part In and the mantissa part Ma in the input number, and then multiplying it by the coefficient SCₘ. The second searching unit 222 is for searching for the n-th entry Tabₘ[n] of the m-th of the plurality of the reference tables such that Tabₘ[n] is not greater than the temporary value Temp, and Tabₘ[n+1] is greater than the temporary value Temp. The second output unit 224 is for outputting n as the m-th digit to the right of the decimal points of the mantissa part Ma. The adding unit 226 is for adding 1 to m. The comparing unit 228 is for comparing m with the number of digits of precision k. If m is not greater than the number of digits of precision k, the logic unit 230 is for asking the second computing unit 220, the second searching unit 222, the second output unit 224, the adding unit 226 and the comparing unit 228 to repeat the steps accordingly. There are many ways to implement the above mentioned searching Tabₘ[n] step, namely step 115; for example, size can be compared from the zeroith entry, or from the fourth or the fifth entry.

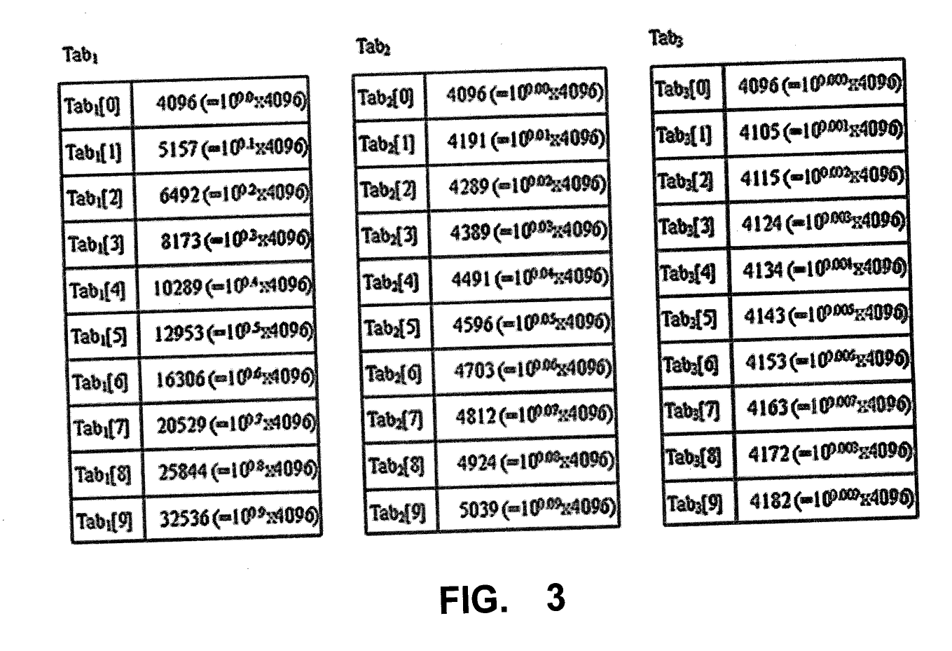

The following is an exemplary logarithm determining method and apparatus in accordance with the present invention. Assume an input number is equal to 135, and a base b is equal to 10. First, the number of digits of precision for the mantissa part Ma, k, is designated as 3. Then, creating a reference table and calculating an integer part In can be processed simultaneously. Alternatively, a reference table can be created prior to when an integer part In is calculated, and vice versa. Assume that the reference table is created first. Refer to FIG. 3 showing an exemplary reference table. Since the number of digits of precision is equal to 3, 3 reference tables are created. The first reference table is for evaluating the first decimal place of the mantissa part Ma, and so on. Each reference table can have 10 entries. The coefficient SCₘ for all 3 reference tables are 4096. The base 10 to the 0-th power is rooted 10¹, and then it is multiplied by SC₁, namely 10^{0.0}*4096. Take 10^{0.0}*4096 as the zeroith entry Tab₁[0] in the first reference table. The base 10 to the first power is rooted 10¹, and then it is multiplied by SC₁, namely 10^{0.1}*4096. Take 10^{0.1}*4096 as the first entry Tab₁[1] in the first reference table, and so on.

Then, the integer part In is calculated. A number y=2 can first be found such that the base b (=10) to the y-th power is not greater than the input number x (=135), and that the base b to the (y+1) power is greater than the input number x, namely 10²≦135<10⁽²⁺¹⁾, then the integer part In is equal to 2.

The reference tables are then searched to obtain the mantissa part Ma.
Set m=1;
If m=1, then eliminate the integer part In (=2) in the x (=135), and then multiply it by SC₁ (=4096) so as to obtain a Temp; Temp being 135*4096/10²=5529.6;
Search for Tab₁ to find n=1 so that Tab₁[1]≦Temp<Tab₁[2], namely 5157≦5529.6<<6492;
Output n (=1) as Ma[1], namely, Ma[1]=1;
Take m+1, namely m=2;
Compare m (=2) with k (=3);
If m≦k, namely 2≦3, then repeat the steps from obtaining Temp to comparing m with k;
If m=2, then eliminate the Integer part In (=2) and Ma[1] (=1) in x (=135), and multiply it by SC₂ (4096) to obtain Temp; Temp being 135*4096/10^{2.1}˜4392;
Search for Tab₂ to find n=3 so that Tab₂[3]≦Temp<Tab₂[4], namely 4389≦4392<4491;
Output n (=3) as Ma[2], namely, Ma[2]=3;
Take m+1, namely m=3;
Compare m (=3) with k (=3);
If m≦k, namely 3≦3, then repeat the steps from obtaining Temp to comparing m with k;
If m=3, then eliminate the integer part In (=2), Ma[1] (=1), and Ma[2] (=3) in the x (=135), and then multiply it by SC₃ (=4096) so as to obtain a Temp; Temp being 135*4096/10^{2.13}=4099;
Search for Tab₃ to find n=0 so that Tab₃[0]≦Temp<Tab₃[1], namely 4096≦4099<4105;
Output n (=0) as Ma[3], namely, Ma[3]=0;
Take m+1, namely m=4;
Compare m (=4) with k (=3);
If m>k, namely 4>3, then end, obtaining the mantissa part Ma=0.130

Finally, the integer part In is equal to 2, the mantissa part is equal to 0.130, and the logarithm L is equal to 2.130, namely log₁₀x=log₁₀135˜2.130.

By means of the detailed descriptions of what is presently considered to be the most practical and preferred embodiments of the subject invention, it is expected that the features and the gist thereof be clearly described. Nevertheless, these embodiments are not intended to be construed in a limiting sense. Instead, it will be well understood that any analogous variations and equivalent arrangements will fall within the spirit and scope of the invention.

1. A method for determining a logarithm in a digital processor, said method converting an input number x into logarithm L by a base b, wherein said logarithm L includes an integer part In and a mantissa part Ma and said method, using a fixed-point format, can represent any numbers, said method comprising the steps of:
designating a number of digits of precision k for said mantissa part Ma;
creating a plurality of reference tables based on said base b, a number of said plurality of reference tables equaling to said number of digits of precision k, an m-th reference table for evaluating an m-th digit to the right of the decimal point of said mantissa part Ma;
calculating said integer part In; and
searching in said plurality of reference tables sequentially to obtain a value from a first to a k-th digit to the right of the decimal point of said mantissa part Ma.

2. The method of claim 1, wherein said calculating step comprises:
searching for a number y such that said base b to the y-th power is not greater than said input number x, and said base b to the (y+1)-th power is greater than said input number x; and
outputting said y as said integer number In.

3. The method of claim 1, wherein each of said reference tables has 10 entries, said creating step comprises:
determining a coefficient SCₘ for said m-th of said plurality of reference tables; and
rooting 10^{m} said base b to the n-th power, and then multiplying said input number by said coefficient SCₘ to be an n-th entry of said m-th of said plurality of said reference tables, where n=0, . . . ,9;
wherein said coefficient SCₘ is for extending intervals among said ten entries.

4. The method of claim 3, wherein said coefficient SCₘ is a power series of 2.

5. The method of claim 3, wherein said searching step comprises:
obtaining a temporary value Temp by eliminating a portion from the first to the (m−1)-th digits to the right of the decimal points of said integer part In and of said mantissa part Ma in said input number, and then multiplying said input number by said coefficient SCₘ;
searching for an n-th entry Tabₘ[n] of said m-th of said plurality of said reference tables such that Tabₘ[n] is not greater than said temporary value Temp, and Tabₘ[n+1] is greater than said temporary value Temp; and
outputting n as the m-th digit to the right of the decimal points of said mantissa part Ma.

6. The method of claim 3, wherein said searching step comprises:
(a) setting m=1;
(b) if m=1, obtaining a temporary value Temp, by eliminating said integer part In in said input number x, and then multiplying said input number by said coefficient SCₘ; or else, obtaining said temporary value Temp, by eliminating said portion from the first to the (m−1)-th digits to the right of the decimal points of said integer part In and of said mantissa part Ma in said input number, and then multiplied by said coefficient SCₘ;
(c) searching for the n-th entry Tabₘ[n] of said m-th of said plurality of said reference tables such that Tabₘ[n] is not greater than said temporary value Temp, and Tabₘ[n+1] is greater than said temporary value Temp;
(d) outputting n as the m-th digit to the right of the decimal points of said mantissa part Ma;
(e) adding 1 to m;
(f) comparing m with said number of digits of precision k; and
(g) if m is not greater than said number of digits of precision k, repeating said steps (b) to (f).

7. A logarithm determining apparatus for converting an input number x into a logarithm L by a base b, wherein said logarithm L includes an integer part In and an mantissa part Ma and said apparatus, using a fixed-point format, can represent any numbers, said apparatus including:
a designating device for designating a number of digits of precision k for said mantissa part Ma;
a creating device for creating a plurality of reference tables based on said base b, a number of said plurality of reference tables equaling to said number of digits of precision k, an m-th reference table for evaluating an m-th digit to the right of the decimal point of said mantissa part Ma;
a calculating device for calculating said integer part In; and
a searching device for searching in said plurality of reference tables sequentially to obtain a first to a k-th digit to the right of the decimal point of said mantissa part Ma.

8. The logarithm determining apparatus of claim 7, comprising:
a first searching unit for searching for a number y such that said base b to the y-th power is not greater than said input number x, and said base b to the (y+1)-th power is greater than said input number x; and
a first output unit for outputting said y as said integer number In.

9. The logarithm determining apparatus of claim 7, wherein each of said reference tables has 10 entries, said creating device includes:
a determining unit for determining a coefficient SCₘ for said m-th of said plurality of reference tables; and
a first computing unit for rooting 10^{m} said base b to the n-th power, and then multiplying said input number by said coefficient SCₘ to be an n-th entry of said m-th of said plurality of said reference tables, where n=0, . . . ,9;
wherein said coefficient SCₘ is for extending intervals among said ten entries.

10. The logarithm determining apparatus of claim 9, wherein said coefficient SCₘ is a power series of 2.

11. The logarithm determining apparatus of claim 9, wherein said searching device includes:
a second computing unit for obtaining a temporary value Temp by eliminating a portion from the first to the (m−1)-th digits to the right of the decimal points of said integer part In and said mantissa part Ma in said input number, and then multiplying said input number by said coefficient SCₘ;
a second searching unit for searching for an n-th entry Tabₘ[n] of said m-th of said plurality of said reference tables such that Tabₘ[n] is not greater than said temporary value Temp, and Tabₘ[n+1] is greater than said temporary value Temp; and
a second output unit for outputting n as the m-th digit to the right of the decimal points of said mantissa part Ma.

12. The logarithm determining apparatus of claim 9, wherein said searching device includes:
(a) a setting unit for setting m=1;
(b) a second computing unit operable, if m=1, to obtain a temporary value Temp, by eliminating said integer part In in said input number x, and then multiplying said input number by said coefficient SCₘ; or else, obtaining said temporary value Temp, by eliminating said portion from the first to the (m−1)-th digits to the right of the decimal points of said integer part In and said mantissa part Ma in said input number, and then multiplying said input number by said coefficient SCₘ;
(c) a second searching unit for searching for the n-th entry Tabₘ[n] of said m-th of said plurality of said reference tables such that Tabₘ[n] is not greater than said temporary value Temp, and Tabₘ[n+1] is greater than said temporary value Temp;
(d) a second output unit for outputting n as the m-th digit to the right of the decimal points of said mantissa part Ma;
(e) an adding unit for adding 1 to m;
(f) a comparing unit for comparing m with said number of digits of precision k; and
(g) a logic unit operable, if m is not greater than said number of digits of precision k, to repeat said steps (b) to (f).
